(19) United States
(12) Patent Application Publication
(10) Pub. No.: US 2003/0099735 A1
(43) Pub. Date: May 29, 2003

(54) Multi-position control cylinder for hot runners of injection molding machines and method of manufacturing such cylinder

(75) Inventor: Young-Hee Yu, Seoul (KR)

Correspondence Address: McDERMOTT, WILL & EMERY, 600 13th Street, N.W., Washington, DC, 20005-3096, US

(73) Assignee: Yudo Co. Ltd

(21) Appl. No.: 10/167,576

(22) Filed: Jun. 13, 2002

(30) Foreign Application Priority Data
Nov. 28, 2001 (KR) 2001-0074489

(51) Int. Cl. B29C 45/76

(52) U.S. Cl. 425/145; 425/549; 29/428

(57) ABSTRACT

A multi-position control cylinder for hot runners of injection molding machines is disclosed. This multi-position control cylinder has a multi-stage hole formed in a unit body, a first cylinder seated in the lower part of the multi-stage hole, and a first piston set in the first cylinder. In addition, a second cylinder is seated in the multi-stage hole at a position above the first cylinder, with a second piston set in the second cylinder. A valve pin is coupled to the second piston using a valve pin coupling member such that the valve pin extends downward from the second piston while passing through the first piston, with the lower portion of the valve pin inserted into the upper portion of the first piston. An anti-vacuum gap is formed between the first piston and the valve pin coupling member. A cylinder head covers the top of the multi-stage hole at a position above the second piston. This multi-position control cylinder has a simple construction, accomplishes a reliable operation, and easily increases the number of cylinders seated in the multi-stage hole by seating a desired number of additional cylinders with pistons in the multi-stage hole.

### BACKGROUND OF THE INVENTION

1. Field of the Invention

The present invention relates, in general, to the structure of multi-position control cylinders for hot runners of injection molding machines and, more particularly, to a multi-position control cylinder for such hot runners, which has a simple construction and performs a desired multi-position control operation by an improved cylinder and piston structure, thus accomplishing desired operational stability, economic efficiency and structural compactness, and to a method of manufacturing such a cylinder.

2. Description of the Prior Art

In the prior art plastic injection molding process, it has been typical to produce plastic products of the same material using one injection mold. However, in recent years, it is necessary to inject two or three kinds of resins into one mold at the same time or sequentially to form a product having improved quality, in addition to achieving desired productivity, during an injection molding process.

Such a requirement of injection of two or three kinds of resins into one mold forces the cylinder for hot runners to be designed as a phase changeable cylinder.

In order to provide such a phase-changeable cylinder for hot runners, a multi-position control cylinder has been proposed. The conventional multi-position control cylinder for hot runners is fabricated by laying a plurality of cylinders such that one is laid on top of another. However, such a conventional multi-position control cylinder is problematic in that it has a complex construction, and limits the space for installation thereof. Therefore, the conventional multi-position control cylinder has not been preferably used with hot runners of injection molding machines.

### SUMMARY OF THE INVENTION

Accordingly, the present invention has been made keeping in mind the above problems occurring in the prior art, and an object of the present invention is to provide a multi-position control cylinder for hot runners of injection molding machines, which has a multi-stage hole formed in a unit body and seats a desired number of cylinders with pistons in the multi-stage hole such that one cylinder is laid on top of another to form a multi-stage cylinder structure, thus having a simple construction and accomplishing a reliable operation, and which easily increases the number of cylinders seated in the multi-stage hole by seating a desired number of additional cylinders with pistons in the multi-stage hole.

In order to accomplish the above objects, the present invention provides a method of manufacturing a multi-position control cylinder for hot runners of injection molding machines, comprising the steps of: forming a multi-stage hole in a unit body; seating a first cylinder in the lower part of the multi-stage hole; setting a first piston in the first cylinder; seating a second cylinder in the multi-stage hole at a position above the first cylinder; coupling a valve pin to a second piston using a valve pin coupling member; setting the second piston with the valve pin in the second cylinder such that the valve pin extends downward from the second piston while passing through the first piston, with the lower portion of the valve pin inserted into the upper portion of the first piston; and covering the top of the multi-stage hole with a cylinder head at a position above the second piston.

The present invention also provides a multi-position control cylinder for hot runners of injection molding machines, comprising: a multi-stage hole formed in a unit body; a first cylinder seated in the lower part of the multi-stage hole; a first piston set in the first cylinder; a second cylinder seated in the multi-stage hole at a position above the first cylinder; a second piston set in the second cylinder; a valve pin coupled to the second piston using a valve pin coupling member such that the valve pin extends downward from the second piston while passing through the first piston, with the lower portion of the valve pin inserted into the upper portion of the first piston; an anti-vacuum gap formed between the first piston and the valve pin coupling member; and a cylinder head covering the top of the multi-stage hole at a position above the second piston.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a multi-position control cylinder for hot runners of injection molding machines in accordance with the preferred embodiment of the present invention;

FIG. 2 is a sectional view of the multi-position control cylinder of this invention when the cylinder is not operated;

FIG. 3 is a sectional view of the multi-position control cylinder of this invention when a first piston of the cylinder is operated; and

FIG. 4 is a sectional view of the multi-position control cylinder of this invention when a second piston of the cylinder is operated.

### DETAILED DESCRIPTION OF THE INVENTION

Reference now should be made to the drawings, in which the same reference numerals are used throughout the different drawings to designate the same or similar components.

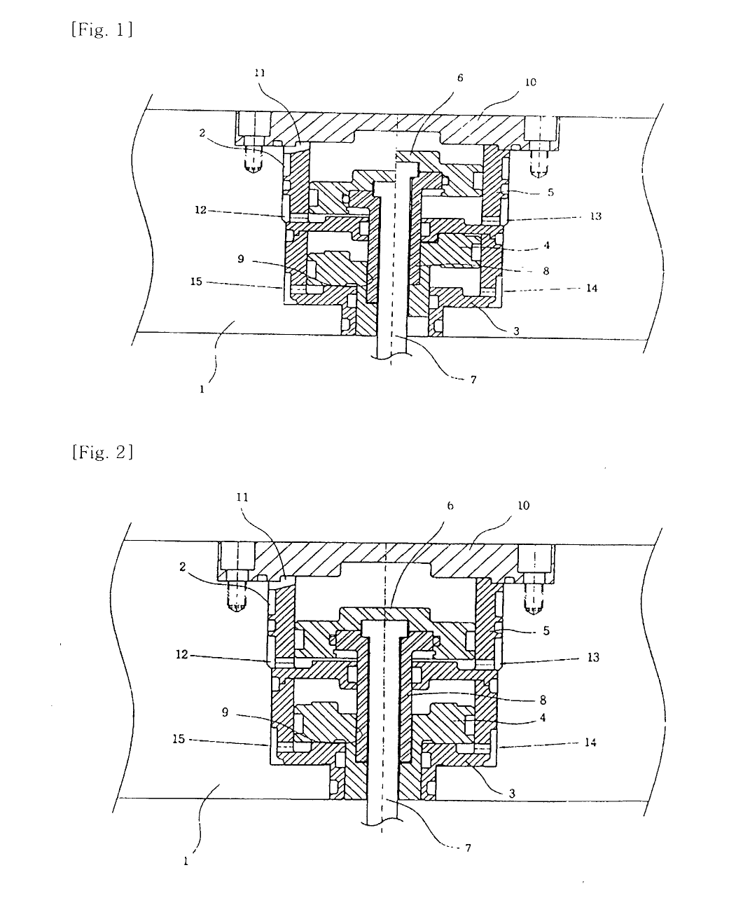

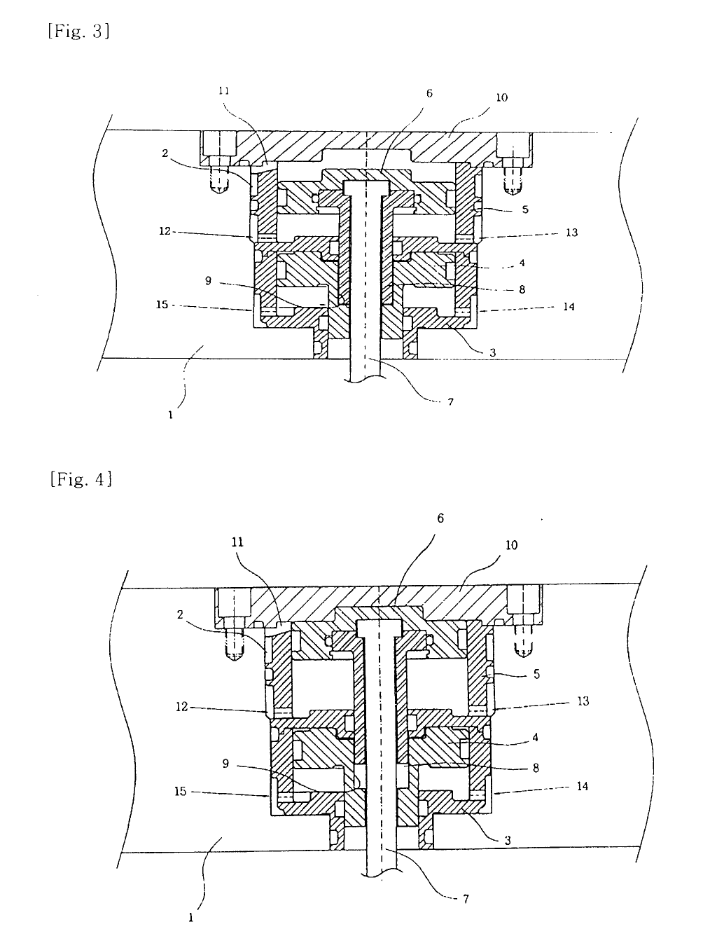

FIG. 1 is a sectional view of a multi-position control cylinder for hot runners of injection molding machines in accordance with the preferred embodiment of the present invention. FIG. 2 is a sectional view of the multi-position control cylinder of this invention when the cylinder is not operated. FIG. 3 is a sectional view of the multi-position control cylinder of this invention when a first piston of the cylinder is operated. FIG. 4 is a sectional view of the multi-position control cylinder of this invention when a second piston of the cylinder is operated.

As shown in the drawings, the multi-position control cylinder according to the preferred embodiment comprises a multi-stage hole 2 formed in a unit body 1 for seating a plurality of cylinders in the unit body 1. A first cylinder 3 having a first piston 4 is seated in the lower part of the multi-stage hole 2. A second cylinder 5 having a second piston 6 is seated in the multi-stage hole 2 at a position above the first cylinder 3. A valve pin 7 is coupled to the second piston 6 using a valve pin coupling member 8. In such a case, the valve pin 7 extends downward from the second piston 6 while passing through the first piston 4, with the lower portion of the valve pin coupling member 8 inserted into the upper portion of the first piston 4. An anti-vacuum gap 9 is formed between the first piston 4 and the valve pin coupling member 8, and so the first and second pistons 4 and 6 are reliably operated in conjunction with each other by the valve pin coupling member 8. A cylinder head 10 covers the top of the multi-stage hole 2 at a position above the second piston 6. The multi-position control cylinder according to the preferred embodiment has two cylinders 3 and 5, thus being operated as a two-position control cylinder. In the drawings, the reference numerals 14 and 15 denote two first fluid ports formed at the lower portion of the first cylinder's sidewall for feeding or discharging pressurized fluid into or from the lower chamber of the first cylinder 3. The numerals 12 and 13 denote two second fluid ports formed at the lower portion of the second cylinder's sidewall for feeding or discharging pressurized fluid into or from the lower chamber of the second cylinder 5. The numeral 11 denotes a third fluid port formed at the upper portion of the second cylinder's sidewall for feeding or discharging pressurized fluid into or from the upper chamber of the second cylinder 5.

When it is desired to produce a three-position control cylinder, a third cylinder having a third piston is seated in the multi-stage hole at a position above the second cylinder 6. Therefore, it is easy to produce a desired multi-position control cylinder by seating a desired number of cylinders in the multi-stage hole 2 of the unit body 1.

The multi-position control cylinder according to the preferred embodiment is produced as follows: First, the multi-stage hole 2 is formed in the unit body 1. After forming the hole 2 in the unit body 1, the first cylinder 3 is seated in the lower part of the hole 2, with the first piston 4 set in the first cylinder 3. After seating the first cylinder 3 in the hole 2, the second cylinder 5 having the second piston 6 is seated in the hole 2 at a position above the first cylinder 3. In such a case, the valve pin 7 is coupled to the second piston 6 using the valve pin coupling member 8 prior to setting the second piston 6 in the second cylinder 5. After seating the second cylinder 6 in the hole 2, the top of the hole 2 is covered with the cylinder head 10.

The multi-position control cylinder of this invention is operated as follows:

When it is desired to open the gates of a hot runner, the valve pin 7 must be moved upward. In order to move the valve pin 7 upward, pressurized air is primarily fed into the lower chamber of the first cylinder 3 through the first fluid ports 14 and 15. The first piston 4 thus moves upward in the first cylinder 3 by pressure of the air. In such a case, pressurized oil in place of pressurized air may be used as an actuation fluid for the multi-position control cylinder.

When it is desired to move the valve pin 7 upward to open the gates of the hot runner, the valve pin 7 moves through a two-step movement as follows.

That is, since the lower portion of the valve pin coupling member 8 is inserted into the upper portion of the first piston 4 without leaving any gap between the lower end of the coupling member 8 and the first piston 4, the upward movement of the first piston 4 causes the coupling member 8 to move in the same direction. Due to the upward movement of the coupling member 8 by the first piston 4, the valve pin 7 moves upward to reach a first position thereof. In such a case, the bottom surface of the second cylinder 5 limits the uppermost position of the upward moving first piston 4, and so it is possible to limit the first position of the valve pin 7.

After the valve pin 7 reaches its first position by the upward movement of the first piston 4, pressurized air is fed into the lower chamber of the second cylinder 5 through the second fluid ports 12 and 13. The second piston 6 thus moves upward in the second cylinder 5, and so the valve pin coupling member 8 moves in the same direction. In such a case, the valve pin coupling member 8 is fixed to the valve pin 7, and so the valve pin 7 moves upward by the upward movement of the coupling member 8 until its reaches a second position thereof. Therefore, the upward movement of the valve pin 7 is accomplished through a two-step movement.

The second cylinder 5 has the three fluid ports 11, 12 and 13 at the upper and lower portions of its sidewall. Therefore, when pressurized air is fed into the lower chamber of the second cylinder 5 through the second fluid ports 12 and 13, the second piston 6 smoothly moves upward in the second cylinder 5 while expelling oil from the upper chamber of the second cylinder 5 through the third fluid port 11. In such a case, the valve pin coupling member 8 moves upward along the second piston 6, and the valve pin 7 smoothly reaches its second position.

When it is desired to close the gates of the hot runner, pressurized air is fed into the upper chamber of the second cylinder 5 through the third fluid port 11. The second piston 6 with the valve pin coupling member 8 thus moves downward in the second cylinder 5, and causes the first piston 4 to move in the same direction.

The first piston 4 is thus returned to its lowermost position while expelling pressurized air from the lower chamber of the first cylinder 3 through the two fluid ports 14 and 15. In addition, it is possible to prevent generation of a vacuum at the junction of the first piston 4 and the valve pin coupling member 8 due to the anti-vacuum gap 9 formed between the first piston 4 and the valve pin coupling member 8. Therefore, the first and second pistons 4 and 6 are reliably operated in conjunction with each other by the valve pin coupling member 8.

As described above, the present invention provides a multi-position control cylinder for hot runners of injection molding machines. The multi-position control cylinder of this invention has a multi-stage hole formed in a unit body, and seats a desired number of cylinders with pistons in the multi-stage hole such that one cylinder is laid on top of another to form a multi-stage cylinder structure. This multi-position control cylinder thus has a simple construction, and accomplishes a reliable operation. The multi-position control cylinder also easily increases the number of cylinders seated in the multi-stage hole by seating a desired number of additional cylinders with pistons in the multi-stage hole.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of manufacturing a multi-position control cylinder for hot runners of injection molding machines, comprising the steps of:
forming a multi-stage hole in a unit body;
seating a first cylinder in a lower part of the multistage hole;
setting a first piston in said first cylinder;
seating a second cylinder in the multi-stage hole at a position above the first cylinder;
coupling a valve pin to a second piston using a valve pin coupling member;
setting the second piston with the valve pin in the second cylinder such that the valve pin extends downward from the second piston while passing through the first piston, with a lower portion of the valve pin inserted into an upper portion of the first piston; and
covering the top of said multi-stage hole with a cylinder head at a position above the second piston.

2. A multi-position control cylinder for hot runners of injection molding machines, comprising:
a multi-stage hole formed in a unit body;
a first cylinder seated in a lower part of the multi-stage hole;
a first piston set in said first cylinder;
a second cylinder seated in the multi-stage hole at a position above the first cylinder;
a second piston set in the second cylinder;
a valve pin coupled to said second piston using a valve pin coupling member such that the valve pin extends downward from the second piston while passing through the first piston, with a lower portion of the valve pin inserted into an upper portion of the first piston;
an anti-vacuum gap formed between the first piston and the valve pin coupling member; and
a cylinder head covering the top of said multi-stage hole at a position above the second piston.

3. The multi-position control cylinder according to claim 2, wherein said first cylinder has a first fluid port at a lower portion thereof for feeding or discharging pressurized fluid into or from a lower chamber of the first cylinder.

4. The multi-position control cylinder according to claim 2, wherein said second cylinder has a second fluid port formed at a lower portion thereof for feeding or discharging pressurized fluid into or from a lower chamber of the second cylinder, and a third fluid port formed at an upper portion of said second cylinder for feeding or discharging pressurized fluid into or from an upper chamber of the second cylinder.

5. The multi-position control cylinder according to claim 2, wherein said first and second pistons are operated in conjunction with each other by the valve pin coupling member.
